(19) United States
(12) Patent Application Publication
(10) Pub. No.: US 2026/0307503 A1
(43) Pub. Date: Oct. 8, 2026

(54) DRIVE APPARATUS FOR VEHICLE

(71) Applicant: TOYOTA JIDOSHA KABUSHIKI KAISHA, Toyota-shi (JP)

(72) Inventor: Isao KOZAWA, Seto-shi (JP)

(73) Assignee: TOYOTA JIDOSHA KABUSHIKI KAISHA, Toyota-shi (JP)

(21) Appl. No.: 19/640,388

(22) Filed: Apr. 6, 2026

(30) Foreign Application Priority Data
Apr. 7, 2025 (JP) 2025-063387

(51) Int. Cl. B60L 15/20

(52) U.S. Cl. CPC B60L 15/20; B60L 2240/423; B60L 2240/463; B60L 2260/20

(57) ABSTRACT

A drive apparatus for a vehicle that includes front and rear wheels. The drive apparatus includes: (a) a main power source including a first electric motor; (b) a center differential configured to distribute an input torque transmitted from the main power source, to the front wheels and the rear wheels; (c) an auxiliary power source including a second electric motor configured to add an additional torque to a rear-side power transmission path; and (d) a control device configured to control the input torque and the additional torque. When a total drive torque is changed with the main power source and the auxiliary power source being operated, the control device is configured to maintain a distribution ratio, which is a ratio of the front drive torque to the total drive torque, at a predetermined constant value.

This application claims priority from Japanese Patent Application No. 2025-063387 filed on Apr. 7, 2025, the disclosure of which is herein incorporated by reference in its entirety.

### FIELD OF THE INVENTION

The present invention relates to a drive apparatus for a vehicle, wherein the drive apparatus includes: a main power source including a first electric motor; a center differential configured to distribute an input torque transmitted from the main power source, to front wheels and rear wheels of the vehicle; an auxiliary power source including a second electric motor configured to add an additional torque to a rear-side power transmission path between the center differential and the rear wheels; and a control device configured to control the input torque and the additional torque.

### BACKGROUND OF THE INVENTION

There is known a vehicle drive apparatus that includes an engine that inputs a drive torque to a center differential that distributes the drive torque to front and rear wheels, an electric motor that adds the drive torque to a rear-side power transmission path between the center differential and the rear wheels, and a control device that controls the drive torque outputted from the engine and the electric motor. An example of such a drive apparatus is disclosed in Patent Document 1.

### PRIOR ART DOCUMENT

### Patent Document

[Patent Document 1] JP 2022-36808 A

### SUMMARY OF THE INVENTION

Here, the drive torque transmitted to the front wheels is referred to as “front drive torque,” and a sum of the drive torque transmitted to the front wheels and rear wheels is referred to as “total drive torque”. In the drive apparatus disclosed in Patent Document 1, for example, when a distribution ratio, which is a ratio of the front drive torque to the total drive torque, is changed in response to change of a ground load of the vehicle without intention of a driver of the vehicle, the driver may experience a sense of discomfort in terms of drivability. That is, a predictability of the driver in terms of drivability will be reduced.

The present invention was made against background of the above circumstances, and its purpose is to provide a drive apparatus for a vehicle, wherein the drive apparatus is capable of suppressing a reduction of the predictability of a of drivability for the driver.

According to the present invention, there is provided a drive apparatus for driving a vehicle that includes front and rear wheels. The drive apparatus includes: (a) a main power source including a first electric motor; (b) a center differential configured to distribute an input torque transmitted from the main power source, to the front wheels and the rear wheels; (c) an auxiliary power source including a second electric motor configured to add an additional torque to a rear-side power transmission path between the center differential and the rear wheels; and (d) a control device configured to control the input torque and the additional torque. When a total drive torque, which is a sum of a front drive torque transmitted to the front wheels and a rear drive torque transmitted to the rear wheels, is changed with the main power source and the auxiliary power source being operated, the control device is configured to maintain a distribution ratio, which is a ratio of the front drive torque to the total drive torque, at a predetermined constant value.

In the drive apparatus according to the present invention, the control device is configured to maintain the distribution ratio of the front drive torque to the total drive torque at the predetermined constant value when the main power source and the auxiliary power source are operated and the total drive torque, which is the sum of the front drive torque and the rear drive torque, is changed. In this way, the control device is configured to maintain the distribution ratio of the front drive torque to the total drive torque at the predetermined constant value. That is, because a distribution ratio of drive torque to the front wheels and the rear wheels is maintained unchanged, the driver will not unintentionally change the distribution ratio of the drive torque, so that it is possible to suppress reduction of the predictability of drivability for the driver, namely, suppress the driver's discomfort in drivability.

### BRIEF DESCRIPTION OF THE DRAWINGS

FIG. 1 is a schematic view of a vehicle equipped with a drive apparatus according to a first embodiment of the present invention, and also a functional block diagram showing main parts of control functions for various controls in the vehicle.

FIG. 2 is an example of a flowchart explaining a control operation performed by an electronic control device shown in FIG. 1.

FIG. 3 is a schematic view of a vehicle equipped with a drive apparatus according to a second embodiment of the present invention, and also a functional block diagram showing main parts of control functions for various controls in the vehicle.

FIG. 4 is an example of a flowchart explaining a control operation performed by an electronic control device shown in FIG. 3.

### DETAILED DESCRIPTION OF PREFERRED EMBODIMENTS

Hereinafter, preferred embodiments of the present invention will be described in detail with reference to the drawings. It is noted that, unless otherwise specified, drawings in each embodiment have been appropriately simplified or modified, and dimensional ratios and shapes of each part are not necessarily accurately depicted.

### First Embodiment

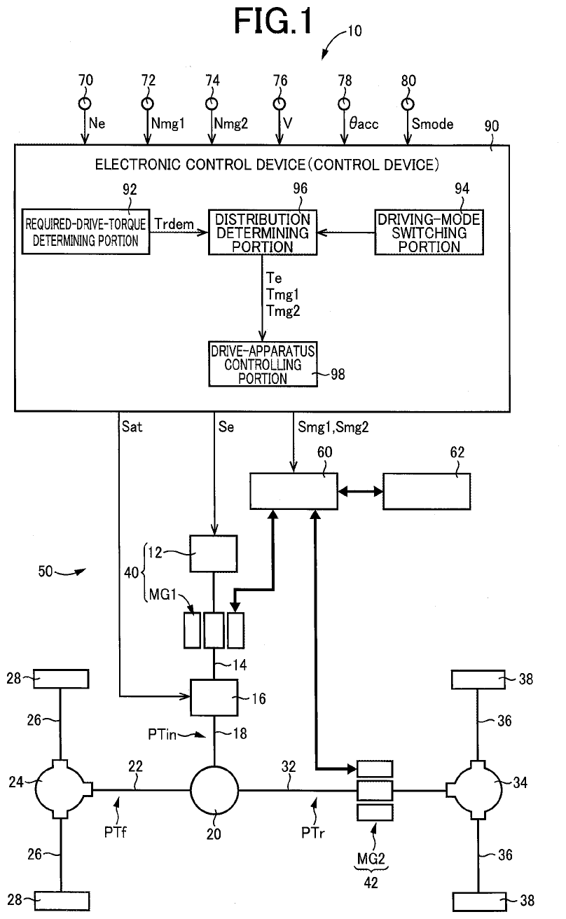

FIG. 1 is a schematic view of a vehicle 10 equipped with a vehicle drive apparatus 50 according to a first embodiment of the present invention, and also a functional block diagram showing main parts of control functions for various controls in the vehicle 10.

The vehicle drive apparatus 50 is a four-wheel drive vehicle equipped with an engine 12, a first electric motor MG1 and a second electric motor MG2 as power sources for driving the vehicle 10, as well as a center differential 20, which are well-known configurations.

The engine 12 is a well-known internal combustion engine. The first electric motor MG1 and the second electric motor MG2 are so-called motor-generators, such as well-known three-phase synchronous motor-generators. The first electric motor MG1 is connected to an output shaft of the engine 12 in a power transmittable manner. The engine 12 and the first electric motor MG1 constitute a main power source 40.

The vehicle drive apparatus 50 includes an automatic transmission 16 on an input-side power transmission path PTin between the main power source 40 and the center differential 20. The main power source 40 and the automatic transmission 16 are connected through a transmission input shaft 14. The automatic transmission 16 and the center differential 20 are connected through a transmission output shaft 18. The automatic transmission 16 has a well-known construction, and changes a rotation speed of the transmission input shaft 14 so as to output it to the transmission output shaft 18. The automatic transmission 16 is controlled by an electronic control device 90 such that a desired gear ratio α is formed from among different gear ratios α. The transmission input shaft 14 is also an output shaft of the main power source 40, and the transmission output shaft 18 is also an input shaft of the center differential 20. The gear ratio α is a ratio (=N1/N2) of a rotational speed N1 [rpm] of the transmission input shaft 14 to a rotational speed N2 [rpm] of the transmission output shaft 18. The automatic transmission 16 changes the rotational speed N2 of the transmission output shaft 18 to 1/α times the rotational speed N1 of the transmission input shaft 14, and a drive torque transmitted from the transmission output shaft 18 to the center differential 20 is α times a drive torque transmitted from the transmission input shaft 14 to the automatic transmission 16. The drive torque transmitted from the transmission output shaft 18 to the center differential 20 is called “input torque Tin [N·m]”.

The vehicle drive apparatus 50 has a front propeller shaft 22, a front differential gear device 24 and a pair of front drive shafts 26, which are provided in this order from side of the center differential 20 on a front-side power transmission path PTf between the center differential 20 and a pair of front wheels 28, and these are of a well-known configuration. Hereinafter, the “pair of front wheels 28” will be simply referred to as “front wheels 28”. The front wheels 28 correspond to the “front wheels” in the present invention. The vehicle drive apparatus 50 has a rear propeller shaft 32, a rear differential gear device 34 and a pair of rear drive shafts 36, which are provided in this order from side of the center differential 20 on a rear-side power transmission path PTr between the center differential 20 and a pair of rear wheels 38, and these are of a well-known configuration. Hereinafter, the “pair of rear wheels 38” will be simply referred to as “rear wheels 38”. The rear wheels 38 correspond to the “rear wheels” in the present invention. The second electric motor MG2 is connected to the rear propeller shaft 32 in a power transmittable manner. The second electric motor MG2 is configured to add an additional torque to the rear-side power transmission path PTr between the center differential 20 and the rear wheels 38. The second electric motor MG2 constitutes an auxiliary power source 42.

The main power source 40 outputs the input torque Tin to the center differential 20 via the automatic transmission 16. The center differential 20 is a well-known configuration that distributes the input torque Tin to the front wheels 28 and rear wheels 38. The center differential 20 distributes only a product (=Tin×γf) of an input torque Tin and a front-wheel-side distribution rate γf to the front propeller shaft 22, and only a product (=Tin×γr) of the input torque Tin and a rear-wheel-side distribution rate γr to the rear propeller shaft 32. The front-wheel-side distribution rate γf is a rate at which the center differential 20 transmits the input torque Tin to the front wheels 28, and the rear-wheel-side distribution rate γr is a rate at which the center differential 20 transmits the input torque Tin to the rear wheels 38. The front-wheel-side distribution rate γf corresponds to the “distribution rate” in the present invention. Each of the front-wheel-side distribution rate γf and the rear-wheel-side distribution rate γr is a value between 0 and 1, and their sum (γf+γr) is 1. In the present embodiment, the front-wheel-side distribution rate γf and rear-wheel-side distribution rate γr of the center differential 20 are fixed values. The center differential 20 may be, for example, a planetary gear center differential with the front-wheel-side distribution rate γf and the rear-wheel-side distribution rate γr being fixed.

The vehicle drive apparatus 50 includes an inverter 60, a battery 62 and the electronic control device 90. The inverter 60 is a well-known power supply circuit that converts direct current to alternating current and vice versa. The first electric motor MG1 and the second electric motor MG2 are connected to the battery 62 via the inverter 60. The inverter 60 is controlled by the electronic control device 90, thereby controlling the output torque of each of the first electric motor MG1 and the second electric motor MG2. The drive torque outputted from the first electric motor MG1 onto the transmission input shaft 14 is referred to as “first electric-motor torque Tmg1 [N·m]”. The drive torque outputted from the second electric motor MG2 onto the rear propeller shaft 32 will be referred to as “second electric-motor torque Tmg2 [N·m]”. The second electric-motor torque Tmg2 is an additional torque Tadd that is added onto the rear propeller shaft 32. The first electric-motor torque Tmg1 and the second electric-motor torque Tmg2 are powering torques when the first electric motor MG1 and the second electric motor MG2 function as electric motors, and are regenerative torques when the first electric motor MG1 and the second electric motor MG2 function as generators. The battery 62 is an electricity storage device that supplies and receives an electric power to and from the first electric motor MG1 and the second electric motor MG2.

In the vehicle 10, one driving mode can be selected from a plurality of driving modes. For example, the driving modes include a normal driving mode, an off-road driving mode and a sports driving mode. The normal driving mode is, for example, a driving mode for paved roads. The normal driving mode is a driving mode that is predetermined to enable driving the vehicle 10 in a state in which fuel consumption and electricity consumption are better than those in the off-road driving mode and sports driving mode. The off-road driving is, for example, a driving mode for unpaved roads. The off-road driving mode is a driving mode that is predetermined to be more suitable for off-road driving than those of the normal driving mode and sports driving mode, and is a driving mode that is selected when, for example, the required drive torque Trdem [N·m] is large. The “required drive torque Trdem” is calculated and determined by applying an accelerator opening degree θacc [%] and an vehicle running speed V [km/h] to a required drive torque map. The required drive torque Trdem is a total drive torque Tr [N·m], which is a sum of the drive torque transmitted to the front wheels 28 and rear wheels 38, and is a drive requested by the driver to the vehicle 10. The required drive torque map is a pre-defined and stored map, determined experimentally or by design, which defines a relationship between the accelerator opening degree θacc, the running speed V and the required drive torque Trdem. The sports driving mode is, for example, a driving mode for paved roads. The sports driving mode is a mode different from the normal driving mode. This driving mode is predetermined to enable driving the vehicle 10 with better power performance as compared to the off-road driving mode, and is selected when it is desired to reduce the drive torque distributed to the steered front wheels 28. The driving mode is switched, for example, by the driver manually operating a driving-mode selection switch 80. The driving-mode selection switch 80 is, for example, a momentary push-button switch. Each time the driver presses the driving-mode selection switch 80, the selected driving mode is switched sequentially from the normal driving mode to the off-road driving mode, from the off-road driving mode to the sports driving mode, and from the sports driving mode to the normal driving mode.

The electronic control device 90 includes, for example, a so-called microcomputer, and executes various controls in the vehicle 10 by processing signals according to a pre-stored program. The electronic control device 90 corresponds to “control device” in the present invention. The electronic control device 90 receives various signals (such as an engine rotational speed Ne [rpm] that is a rotational speed of the engine 12; a first-electric-motor rotational speed Nmg1 [rpm] that is a rotational speed obtained by converting a rotational speed of the first electric motor MG1 to a rotational speed on the transmission input shaft 14; a second-electric-motor rotational speed Nmg2 [rpm] that is a rotational speed obtained by converting a rotational speed of the second electric motor MG2 to a rotational speed on the rear propeller shaft 32; a vehicle running speed V; an accelerator opening degree θacc that is an amount of an accelerator operation indicating a magnitude of the driver's acceleration operation and a mode selection signal Smode that indicates the driving mode selected by the driver's manual operation of the driving-mode selection switch 80) based on values detected by various sensors (such as a rotational speed sensor 70, a rotational speed sensor 72, a rotational speed sensor 74, a vehicle speed sensor 76, an accelerator opening-degree sensor 78 and a driving-mode selection switch 80). The electronic control device 90 outputs various control signals (such as an engine control signal Se for controlling the engine 12, a first-electric-motor control signal Smg1 for controlling the first electric motor MG1, a second-electric-motor control signal Smg2 for controlling the second electric motor MG2 and a shift control signal Sat for controlling a shift operation of the automatic transmission 16) to various devices (such as the engine 12, the inverter 60 and the automatic transmission 16). In this way, the engine rotational speed Ne, an engine torque Te [N·m], the first-electric-motor rotational speed Nmg1, the first-electric-motor torque Tmg1, the second-electric-motor rotational speed Nmg2 and the second-electric-motor torque Tmg2 are controlled by the electronic control device 90. The engine torque Te is an output torque of the engine 12.

Next, there will be described the control functions of the electronic control device 90 when the engine 12, first electric motor MG1 and second electric motor MG2 are operated and the total drive torque Tr is changed.

The electronic control device 90 functionally includes a required-drive-torque determining portion 92, a driving-mode switching portion 94, a distribution determining portion 96 and a drive-apparatus controlling portion 98.

The required-drive-torque determining portion 92 determines the required drive torque Trdem based on the actual accelerator opening degree θacc and running speed V. The driving-mode switching portion 94 switches to the driving mode selected by the driver's manual operation of the driving-mode selection switch 80.

When the distribution determining portion 96 determines that the driving mode switched by the driving-mode switching portion 94 is the normal driving mode, it sets an input-torque share ratio k to a share ratio value k0. The input-torque share ratio k is a ratio of the input torque Tin to the required drive torque Trdem (=Tin/Trdem). The input-torque share ratio k corresponds to “share ratio” in the present invention. When the distribution determining portion 96 determines that the driving mode switched by the driving-mode switching portion 94 is the off-road driving mode, it sets the input-torque share ratio k to a share ratio value k1 (>k0). When the distribution determining portion 96 determines that the driving mode switched by the driving-mode switching portion 94 is the sports driving mode, it sets the input-torque share ratio k to a share ratio value k2 (<k0). Each of the share ratio values k0, k1, k2 is a constant value predetermined experimentally or by design for a corresponding one of the driving modes, and corresponds to “another predetermined constant value” in the present invention. The distribution determining portion 96 determines whether to execute shift control for the automatic transmission 16. The distribution determining portion 96 determines whether to shift the automatic transmission 16, for example, using a shift map. The shift map is a well-known, predetermined relationship that has shift lines on a two-dimensional coordinate system with variables such as the running speed V and the required drive torque Trdem, for determining whether to shift the automatic transmission 16. The distribution determining portion 96 calculates and determines the input torque Tin based on equation (1).

$$Tin = k \times Trdem \qquad ( 1 )$$

Now, there will be described a case in which the distribution determining portion 96 determines not to execute the shift control.

The distribution determining portion 96 obtains a current gear ratio α0. Since equation (2) is satisfied, the distribution determining portion 96 calculates and determines the first electric-motor torque Tmg1 based on equation (3) by using equations (1) and (2). It is noted that an output torque Tmain is an output torque of the main power source 40 and is a sum of the engine torque Te and the first electric-motor torque Tmg1. The distribution determining portion 96 calculates and determines the second electric-motor torque Tmg2 based on equation (4).

$$Tin = Tmain / α0 = ( Te + Tmg 1 ) / α0 \qquad ( 2 )$$

$$Tmg 1 = ( k \times Trdem ) \times α0 - Te \qquad ( 3 )$$

$$Tmg 2 = ( 1 - k ) \times Trdem \qquad ( 4 )$$

The drive-apparatus controlling portion 98 controls the outputs of the main power source 40 and the auxiliary power source 42 such that the first electric-motor torque Tmg1 and the second electric-motor torque Tmg2 determined by the distribution determining portion 96 are obtained. It is noted that the engine torque Te is more difficult to be changed in a short period of time than the first electric-motor torque Tmg1. Therefore, it is preferable to keep the engine torque Te constant and change the first electric-motor torque Tmg1 such that equation (3) is satisfied.

When the distribution determining portion 96 determines not to execute the shift control, the drive-apparatus controlling portion 98 executes the output control. The front drive torque Trf [N⋅m] and rear drive torque Trr [N·m] are expressed by equations (5) and (6). The input-torque share ratio k is a constant value between k0 and k2 determined based on the driving mode selected by the driver, and the front-wheel-side distribution rate γf is also a fixed value. In this way, a ratio of the front drive torque Trf to the rear drive torque Trr is controlled to a constant ratio of (k×γf):(1−k×γf). That is, the electronic control device 90 is configured to maintain the distribution ratio β (=Trf/Tr) of the front drive torque Trf to the total drive torque Tr at a predetermined constant value (=k×γf). The sum of the front drive torque Trf and the rear drive torque Trr is the required drive torque Trdem. It is noted that the predetermined constant value (=k ×γf) corresponds to the “predetermined constant value” in the present invention.

$$\begin{matrix}Trf = Tin \times γ f \\ = ( k \times Trdem ) \times γ f \\ = ( k \times γ f ) \times Trdem\end{matrix} \qquad ( 5 )$$

$$\begin{matrix}Trr = Tin \times γ r + Tmg 2 \\ = ( k \times Trdem ) \times ( 1 - γ f ) + ( 1 - k ) \times Trdem \\ = ( 1 - k \times γ f ) \times Trdem\end{matrix} \qquad ( 6 )$$

Now, there will be described a case in which the distribution determining portion 96 determines to execute the shift control.

The distribution determining portion 96 obtains a gear ratio α1 after execution of the shift control, i.e., after the gear change. Since equation (7) is satisfied, the distribution determining portion 96 calculates and determines the first electric-motor torque Tmg1 after the gear change, based on equation (8) from equations (1) and (7). The distribution determining portion 96 calculates and determines the second electric-motor torque Tmg2 after the gear change based on the above-described equation (4).

$$Tin = Tmain / α1 = ( Te + Tmg 1 ) / α1 \qquad ( 7 )$$

$$Tmg 1 = ( k \times Trdem ) \times α1 - Te \qquad ( 8 )$$

The drive-apparatus controlling portion 98 executes the shift control for the automatic transmission 16 and also executes the output control for the main power source 40 and the auxiliary power source 42, so as to obtain the post-shift first electric-motor torque Tmg1 and the post-shift second electric-motor torque Tmg2 determined by the distribution determining portion 96.

In the output control after the shift control by the drive-apparatus controlling portion 98 when the distribution determining portion 96 determines to execute the shift control, the front drive torque Trf and the rear drive torque Trr are expressed by the above-described equations (5) and (6). Therefore, the electronic control device 90 is configured to maintain the distribution ratio β at the predetermined constant value (=k×γf). In addition, the sum of the front drive torque Trf and the rear drive torque Trr is the required drive torque Trdem.

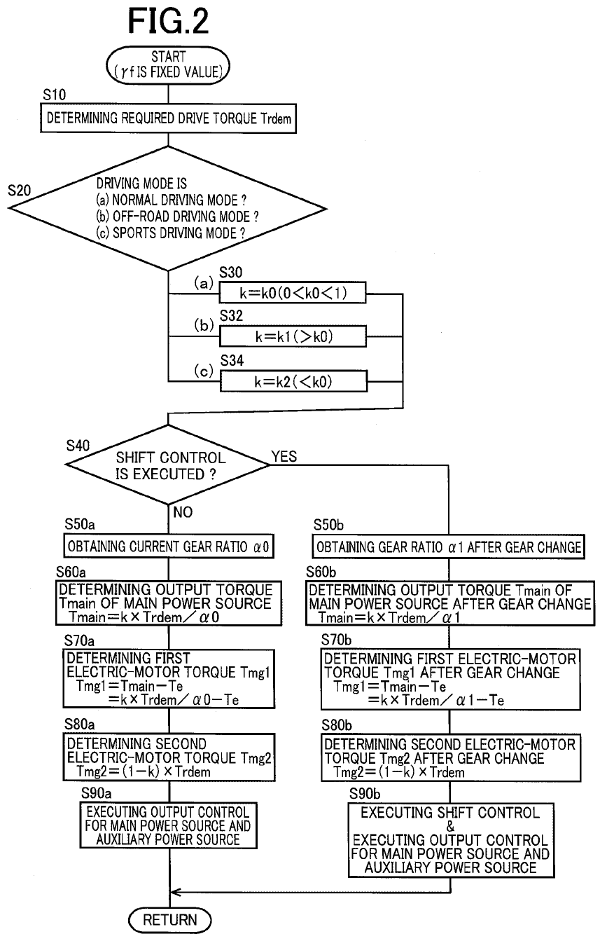

FIG. 2 is an example of a flowchart showing a control routine executed by the electronic control device 90 shown in FIG. 1. The control routine shown in the flowchart of FIG. 2 is repeatedly executed when the engine 12, first electric motor MG1 and second electric motor MG2 are operated and the total drive torque Tr is to be changed.

The control routine is initiated with step S10 that is implemented to determine the required drive torque Trdem. Then, step S20 is implemented to determine the driving mode. When the driving mode is determined to be the normal driving mode at step S20, the input-torque share ratio k is set to a share ratio value k0 at step S30. When the driving mode is determined to be the off-road driving mode at step S20, the input-torque share ratio k is set to a share ratio value k1 at step S32. When the driving mode is determined to be the sports driving mode at step S20, the input-torque share ratio k is set to a share ratio value k2 at step S34. After steps S30 through S34 have been implemented, step S40 is implemented to determine whether or not to execute the shift control for the automatic transmission 16.

When a negative determination is made at step S40, namely, when the shift control is not to be executed, the current gear ratio α0 is obtained at step S50a. After implementation of S50a, the output torque Tmain [N·m] of the main power source 40 is determined at step S60a, the first electric-motor torque Tmg1 is determined at step S70a, and the second electric-motor torque Tmg2 is determined at step S80a. After implementation of step S80a, the output control for the main power source 40 and the auxiliary power source 42 is executed at step S90a, such that the first electric-motor torque Tmg1 and the second electric-motor torque Tmg2 determined at steps S70a and S80a are obtained. On the other hand, when an affirmative determination is made at step S40, namely, when the shift control is to be executed, the gear ratio α1 after the gear change is obtained at step S50b. After implementation of S50b, the output torque Tmain of the main power source 40 after the gear change is determined at step S60b, the first electric-motor torque Tmg2 after the gear change is determined at step S70b, and the second electric-motor torque Tmg2 after the gear shift is determined at step S80b. After implementation of step S80b, step S90b is implemented to execute the shift control for the automatic transmission 16, and execute the output control for the main power source 40 and auxiliary power source 42 such that the first electric-motor torque Tmg1 after the gear shift and the second electric-motor torque Tmg2 after the gear shift determined at steps S70b and S80b are obtained. After implementation of step S90a or S90b, one cycle of execution of the control routine is terminated.

According to the present embodiment, the input-side power transmission path PTin between the main power source 40 and the center differential 20 is provided with the automatic transmission 16, and the electronic control device 90 is configured to maintain the distribution ratio β at the predetermined constant value (=k×γf) when executing the shift control for the automatic transmission 16, even if the gear ratio α of the automatic transmission 16 is changed. That is, because the distribution ratio of the drive torque to the front wheels 28 and the rear wheels 38 is maintained unchanged, the driver will not unintentionally change the distribution ratio of the drive torque, so that it is possible to suppress reduction of the predictability of drivability for the driver, namely, suppress the driver's discomfort in drivability.

According to the present embodiment, (a) the front-wheel-side distribution rate γf, at which the center differential 20 distributes the input torque Tin to the front wheels 28, is constant, and (b) the electronic control device 90 maintains the input-torque share ratio k at one of the share ratio values k0-k2, which are predetermined constant values, when maintaining the distribution ratio β at a predetermined constant value. When the front-wheel-side distribution rate γf is constant, the electronic control device 90 simply maintains the input-torque share ratio k at one of the share ratio values k0-k2, which are predetermined constant values, so that the distribution ratio β can be maintained at a predetermined constant value. This suppresses any discomfort that the driver could feel in terms of drivability.

According to the present embodiment, the electronic control device 90 maintains the distribution ratio β at the predetermined constant value (=k×γf) by switching the input-torque share ratio k in accordance with the driving mode selected by the driver. By switching the predetermined constant value (=k×γf) at which the distribution ratio β is maintained in accordance with the driving mode, the distribution ratio of the drive torque to the front drive torque Trf and the rear drive torque Trr that is suitable for the driving mode selected by the driver is realized. For example, in the off-road driving mode in which the required drive torque Trdem is relatively large, the tire grip force can be made maximum use of in the so-called friction circle by making the distribution ratio β (=Trf/Tr) larger than in the normal driving mode. For example, in the sports driving mode, the distribution ratio β can be made smaller than in the normal driving mode so as to increase a margin of the tire grip force in the friction circle on side of the front wheels 28, thereby improving a turning ability of the vehicle 10.

### Second Embodiment

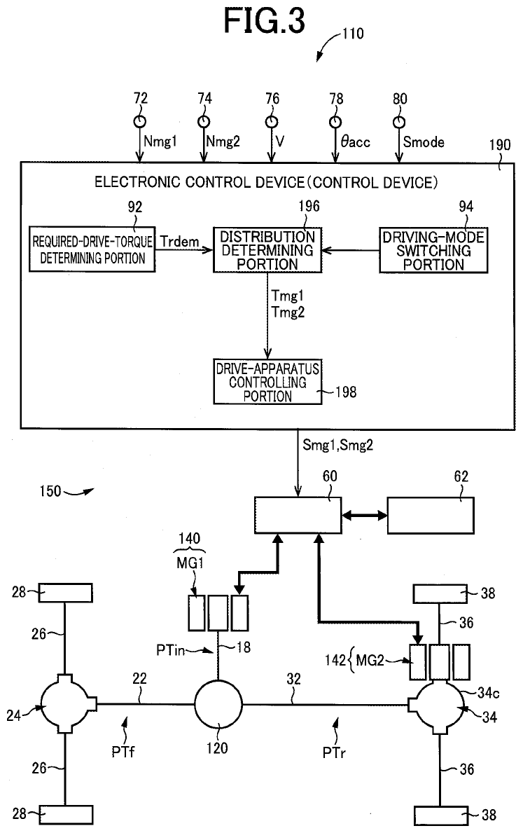

FIG. 3 is a schematic view of a vehicle 110 equipped with a drive apparatus 150 according to a second embodiment of the present invention, and also a functional block diagram showing main parts of control functions for various controls in the vehicle 110. The vehicle drive apparatus 150 has substantially the same construction as the vehicle drive apparatus 50 according to the above-described first embodiment, but differs mainly in that (a) a main power source 140 is provided instead of the main power source 40, (b) a center differential 120 is provided instead of the center differential 20, (c) the automatic transmission 16 is not provided between the main power source 140 and the center differential 120, (d) an auxiliary power source 142 is provided instead of the auxiliary power source 42, and (e) an electronic control device 190 is provided instead of the electronic control device 90. Therefore, in the present second embodiment, the differences from the first embodiment will be mainly described, the same reference numerals are used to designate parts that are substantially the same in function as those of the first embodiment, and the explanations thereof will be omitted as appropriate.

The main power source 140 has substantially the same construction as the main power source 40 described above, except that it does not include the engine 12 and only has the first electric motor MG1. The output torque Tmain is equal to the first electric-motor torque Tmg1 and is also the input torque Tin. The center differential 120 has substantially the same construction as center differential 20 described above, except that the front-wheel-side distribution rate γf is variable. The center differential 120 may be, for example, an electronically controlled center differential equipped with a differential limiting mechanism that varies the front-wheel-side distribution rate γf and rear-wheel-side distribution rate γr, and the differential limiting is electronically controlled. The auxiliary power source 142 has substantially the same construction as the above-described auxiliary power source 42, except that the second electric motor MG2 is connected to the differential casing 34c of the rear differential gear device 34 in a power transmittable manner. Thus, as in the above-described first embodiment, the second electric motor MG2 is configured to add the drive torque to the rear-side power transmission path PTr between the center differential 120 and the rear wheels 38.

Hereinafter, there will be described the control functions of the electronic control device 190 when the engine 12, first electric motor MG1 and second electric motor MG2 are operated and the total drive torque Tr is to be changed.

The electronic control device 190 functionally includes the required-drive-torque determining portion 92, the driving-mode switching portion 94, a distribution determining portion 196 and a drive-apparatus controlling portion 198.

When the distribution determining portion 196 determines that the driving mode switched by the driving-mode switching portion 94 is the normal driving mode, the distribution determining portion 196 sets the product R (=k×γf) of the input-torque share ratio k and the front-wheel-side distribution rate γf to a constant value R0, and sets the input-torque share ratio k to R0/γf. When the distribution determining portion 196 determines that the driving mode switched by the driving-mode switching portion 94 is the off-road driving mode, the distribution determining portion 196 sets the product R to a constant value R1 (>R0), and sets the input-torque share ratio k to R1/γf. When the distribution determining portion 196 determines that the driving mode switched by the driving-mode switching portion 94 is the sports driving mode, the distribution determining portion 196 sets the product R to a constant value R2 (<R0), and sets the input-torque share ratio k to R2/γf. In this way, the distribution determining portion 196 changes the front-wheel-side distribution rate γf and the input-torque share ratio k, in accordance with the driving mode selected by the driver, without changing the product R (=k×γf). It is noted that each of the constant values R0, R1, and R2 is a constant value that is predetermined experimentally or by design in accordance with the corresponding driving mode, and corresponds to “predetermined constant value” in the present invention.

Since the first electric-motor torque Tmg1 is equal to the input torque Tin, the distribution determining portion 196 calculates and determines the first electric-motor torque Tmg1 based on equation (9). The distribution determining portion 196 calculates and determines the second electric-motor torque Tmg2 based on the above-described equation (4).

$$Tmg 1 = Tin = ( k \times Trdem ) \qquad ( 9 )$$

The drive-apparatus controlling portion 198 controls the output of each of the main power source 140 and the auxiliary power source 142 so as to obtain the first electric-motor torque Tmg1 and the second electric-motor torque Tmg2 determined by the distribution determining portion 196.

In the output control by the drive-apparatus controlling portion 198, the front drive torque Trf and the rear drive torque Trr are expressed by equations (5) and (6), as in the first embodiment. The product R (=k×γf) is one of the constant values R0 to R2. In this way, the ratio of the front drive torque Trf and the rear drive torque Trr is controlled to be a constant ratio of (k×γf): (1−k×γf). That is, the electronic control device 190 is configured to maintain the distribution ratio β at the predetermined constant value (=k×γf).

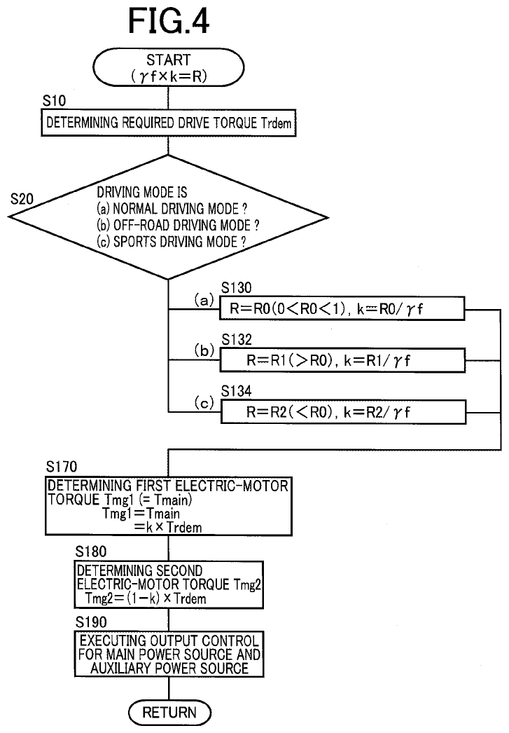

FIG. 4 is an example of a flowchart showing a control routine executed by the electronic control device 190 shown in FIG. 3. The control routine shown in the flowchart of FIG. 4 is repeatedly executed when the first electric motor MG1 and second electric motor MG2 are operated and the total drive torque Tr is to be changed.

The control routine shown in FIG. 4 is substantially the same as the control routine shown in FIG. 2 in the above-described first embodiment, but differs in that steps S130 to S134 replace steps S30 to S34, respectively, and that there is no determination at step S40, and that steps S170 to S190 are implemented after steps S130 to S134 are implemented.

When the driving mode is determined to be the normal driving mode at step S20, then at step S130, the product R (=k×γf) is determined to be the constant value R0, and the input-torque share ratio k is determined to be R0/γf. When the driving mode is determined to be the off-road driving mode at step S20, then at step S132, the product R is determined to be the constant value R1 (>R0), and the input-torque share ratio k is determined to be R1/γf. When the driving mode is determined to be the sports driving mode at step S20, then at step S134, the product R is determined to be the constant value R2 (<R0), and the input-torque share ratio k is determined to be R2/γf. After steps S130 to S134 are implemented, the first electric-motor torque Tmg1 is determined at step S170, and the second electric-motor torque Tmg2 is determined at step S180. After step S180 is implemeted, at step S190, the output control for the main power source 140 and the auxiliary power source 142 is executed such that the first electric-motor torque Tmg1 and second electric-motor torque Tmg2 determined at steps S170 and S180 are obtained. After implementation of step S190, one cycle of execution of the control routine is terminated.

According to the present second embodiment, when maintaining the distribution ratio β at the predetermined constant value, the electronic control device 190 maintains the product R (=k×γf) at one of the constant values R0 to R2 determined in accordance with the driving mode selected by the driver. Because the product R is maintained at the constant value, the distribution ratio of the drive torque to the front wheels 28 and the rear wheels 38 is maintained unchanged, the driver will not unintentionally change the distribution ratio of the drive torque, so that it is possible to suppress reduction of the predictability of drivability for the driver.

The above-described embodiments of the present invention are merely examples, and the present invention can be embodied in various forms with various modifications and improvements made based on the knowledge of those skilled in the art without departing from the spirit of the present invention.

In the above-described first and second embodiments, there are three driving modes consisting of the normal driving mode, off-road driving mode and sports driving mode. However, the present invention is not limited to this. There may be four or more driving modes, or there may be only two or one driving mode.

For example, in the above-described first embodiment, the center differential 20 may have a torque-sensitive or other differential limiting function. In this case, stability during turning of the vehicle 10 can be improved.

The present invention is applicable to a case in which the automatic transmission 16 is not provided in the above-described first embodiment, and also to a case in which an automatic transmission is provided in the input-side power transmission path PTin in the above-described second embodiment. Where no automatic transmission is provided, this is equivalent to having a virtual automatic transmission with gear ratio α of “1.” The present invention is also applicable to a case in which a pair of gears with a fixed gear ratio is provided instead of the automatic transmission 16.

The present invention is applicable to a case in which the main power source 40 does not include the engine 12 but includes only the first electric motor MG1 in the above-described first embodiment, and is applicable also to a case in which the main power source 140 includes the engine 12 in the above-described second embodiment. Further, the present invention is also applicable to a case in which each of the auxiliary power sources 42, 142 includes a power source other than the second electric motor MG2 in the above-described first and second embodiments.

### NOMENCLATURE OF ELEMENTS

16: automatic transmission
20; 120: center differential
28: a pair of front wheels
38: a pair of rear wheels
40; 140: main power source
42; 142: auxiliary power source
50; 150: vehicle drive apparatus
90; 190: electronic control device
k: input-torque share ratio (share ratio)
k0, k1, k2: share ratio value (another predetermined constant value)
MG1: first electric motor
MG2: second electric motor
PTin: input-side power transmission path
PTr: rear-side power transmission path
R: product
R0,R1,R2: constant value (predetermined constant value)
Tin: input torque
Tmg2: second electric-motor torque (additional torque)
Tr: total drive torque
Trdem: required drive torque
Trf: front drive torque
Trr: rear drive torque
α: gear ratio β: distribution ratio γf: front-wheel-side distribution rate (distribution rate)

What is claimed is:

1. A drive apparatus for driving a vehicle that includes front and rear wheels,
the drive apparatus comprising:
a main power source including a first electric motor;
a center differential configured to distribute an input torque transmitted from the main power source, to the front wheels and the rear wheels;
an auxiliary power source including a second electric motor configured to add an additional torque to a rear-side power transmission path between the center differential and the rear wheels; and
a control device configured to control the input torque and the additional torque,
wherein, when a total drive torque, which is a sum of a front drive torque transmitted to the front wheels and a rear drive torque transmitted to the rear wheels, is changed with the main power source and the auxiliary power source being operated, the control device is configured to maintain a distribution ratio, which is a ratio of the front drive torque to the total drive torque, at a predetermined constant value.

2. The drive apparatus according to claim 1,
wherein, when the distribution ratio is maintained at the predetermined constant value, the control device is configured to maintains a product of a distribution rate, at which the input torque is distributed to the front wheels, and a share ratio of the input torque to a required drive torque required by the vehicle, at the predetermined constant value, and is configured to set the additional torque to a product of the required drive torque and a value obtained by subtracting the share ratio from 1.

3. The drive apparatus according to claim 2,
wherein the distribution rate, at which the input torque is distributed by the center differential to the front wheels, is constant, and
wherein, when the distribution ratio is maintained at the predetermined constant value, the control device is configured to maintain the share ratio at another predetermined constant value.

4. The drive apparatus according to claim 1,
wherein the control device is configured to switch the predetermined constant value, depending on a driving mode selected by a driver of the vehicle.

5. The drive apparatus according to claim 1, further comprising an automatic transmission provided in an input-side power transmission path between the main power source and the center differential,
wherein, when a shift control for the automatic transmission is executed, the control device is configured to maintain the distribution ratio at the predetermined constant value even if a gear ratio of the automatic transmission is changed.
